(19) United States
(12) Patent Application Publication
(10) Pub. No.: US 2007/0272167 A1
(43) Pub. Date: Nov. 29, 2007

(54) Leash

(76) Inventor: Darren J. Bird, Auckland (NZ)

Correspondence Address: WILMER CUTLER PICKERING HALE AND DORR LLP, 60 STATE STREET, BOSTON, MA, 02109, US

(21) Appl. No.: 10/565,310

(22) PCT Filed: Jul. 16, 2004
(86) PCT No.: PCT/NZ04/00152

§ 371 Date: Oct. 2, 2006

(30) Foreign Application Priority Data
Jul. 18, 2003 (NZ) 527068

(51) Int. Cl. A01K 15/04

(52) U.S. Cl. 119/801

(57) ABSTRACT

An animal leash is provided which has a container (12) to which a strap (1) is attached for clipping to an animal collar (20). The container (12) has a handle that allows the user to pull on the leash. The strap (1) may include a sliding D ring to allow the strap (1), when disconnected from the container (12), to be secured about an appropriate fixed or stationary object.

### FIELD OF THE INVENTION

This invention relates to a leash, and is directed particularly, but not solely, toward an animal leash suitable for a user to walk an animal such as a dog.

### BACKGROUND OF THE INVENTION

Known animal leashes typically comprise a strap which has a clip at one end to attach to a collar of an animal. The other end of the strap usually has a loop which is formed by stitching a part of the strap to itself. The apparatus is used by a user placing a hand, arm or fingers, for example, through the loop so as to restrain the animal, or to at least constrain the range of movement of the animal relative to the user.

Users often use a leash to exercise their animal while they themselves also exercise. Thus a user will often be attired in exercise clothing, for example, while exercising the animal. This creates a difficulty in relation to items that a user may usually store in a pocket of conventional clothing. For example, the user may wish to take personal items keys, a wallet and perhaps a mobile telephone when exercising the animal, but exercise clothing usually has few pockets. Also, exercise clothing that does have pockets is often not adapted to carry objects that may be somewhat heavy and bulky, such as wallets. Bulky objects can also make exercise clothing appear unflattering. Therefore, carrying these objects is inconvenient.

Although some leash devices allow a separate receptacle to be attached to the strap, these are designed for collecting excrement, so they are not typically suitable for personal items such as car keys or house keys, wallets, etc. Also, these existing containers have the disadvantage that they are not removable, or not easily removable, from the leash strap.

### Object

It is an object of the present invention to provide an animal leash which will at least go some way toward overcoming disadvantages of known animal leashes, or to at least provide the public with a useful alternative.

### SUMMARY OF THE INVENTION

Accordingly in one aspect the invention may broadly be said to consist in a leash comprising an elongate strap having a first end and a second end, the first end having a collar connector for connection to an animal collar, the second end having a container connector for connection to a container, a container having a strap connector for connection to the container connector, and the container including a leash handle adapted to be grasped by the hand of a user.

Preferably the strap may include a further connector near the second end thereof adapted to engage with the container connector.

Preferably or alternatively the leash may include a slideable connector sideably mounted about the strap, the slideable connector being adapted to engage with the container connector.

Preferably the leash includes a collar having a strap connector adapted to engage the collar connector.

Preferably the collar includes a collar fastening means such as a buckle.

Preferably the collar includes a fastening loop such as a “D” ring for containing the tongue of the collar and/or for attaching registration tags, identification tags and such devices as Pet Blinkers™ or safety lights.

Preferably the collar strap connector is fixedly mounted on the collar in a location substantially opposite the fastening means.

Preferably the container has a first end and a second end, the strap connector being provided at the first end of the container, and the handle being provided at the second end of the container.

In a further aspect the invention may broadly be said to consist in a leash comprising an elongate strap having a first end and a second end, the first end having a collar connector for connection to an animal collar, the second end having a container connector for connection to a container, the container having a substantially triangular shape and including a strap connector provided at or adjacent to an apex of the triangular shape for connection to the container connector, and the container including a leash handle at a side of the triangular shape substantially opposite the apex, the leash handle being adapted to be grasped by the hand of the user.

Preferably the container is constructed from a substantially flexible material.

In a further aspect of the invention it may broadly be said to consist in an animal collar having a fastening means such as a buckle to fasten a collar about the neck of an animal, and a strap connector adapted to engage the collar with a leash strap, the strap connector being fixedly located to the collar so as not to move substantially along the collar, and the strap connector being mounted on the collar in a location substantially opposite the location of the fastening means.

Preferably the collar includes a strap, the strap being engaged with the strap connector.

Preferably the strap includes a container with a further strap connector being provided at a first end of the container.

### DRAWING DESCRIPTION

The invention will now be described by way of example with reference to the accompanying drawings, in which:

FIG. 1: is a perspective view of one example of a strap for a leash,

FIG. 2: is a perspective view of a container for a leash,

FIG. 3: is a perspective view of a collar for a leash,

FIG. 4: is a perspective view of a leash including apparatus of FIGS. 1 to 3 in an assembled condition,

FIG. 5: is a perspective view of another example of a strap for a leash, and

FIG. 6: is a perspective view of another example of a strap for a leash, the strap including features of the strap shown in FIGS. 1 and 5.

### DETAILED DESCRIPTION

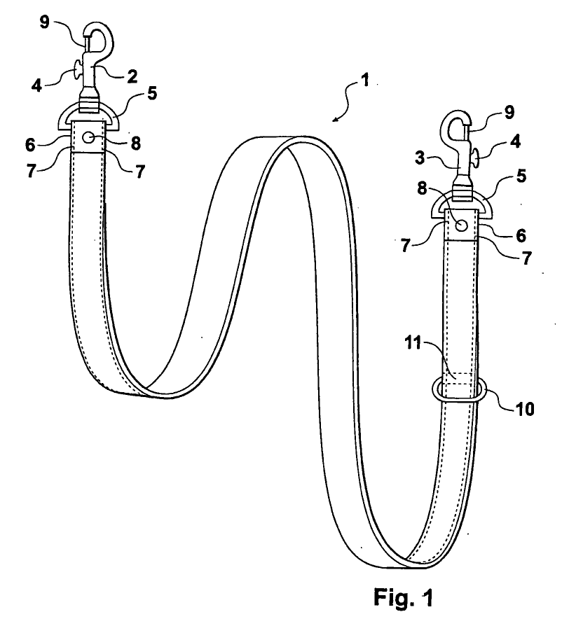

Referring to FIG. 1, a strap is shown generally referenced 1, having a first end with a collar clip 2 and a second end with a container clip 3. Each of the clips is readily available, having a known operating function whereby the clip is biased into a closed state by a spring, but is capable of being transformed to an open state by a manually manipulable lever such as protrusion 4 which is connected to a pin 9. A user may use a finger such as a thumb for example to manipulate protrusion 4 to move pin 9 away to open the clip. A part of a connector such as a loop or ring can then be placed into the opening, and the protrusion can be released to allow clip to revert to its closed state to connect to the ring or loop.

In the example illustrated, the clips 2 and 3 are attached to each end of the strap 1 by a loop or ring 5 which is constructed of a suitably strong and tough material such as metal for example. The ring 5 which is shown in the example is commonly referred to as a D ring, and the straight part of the D ring is provided within a closed loop 6 at each end of the strap. The loop 6 is typically formed by stitching 7 which stitches the strap to itself, and may also be secured using a further fastener such as a rivet 8.

The strap 1 also includes a further loop such as D ring 10 which is permanently affixed in a predetermined location on the strap, for example by being stitched into place as shown by stitching 11.

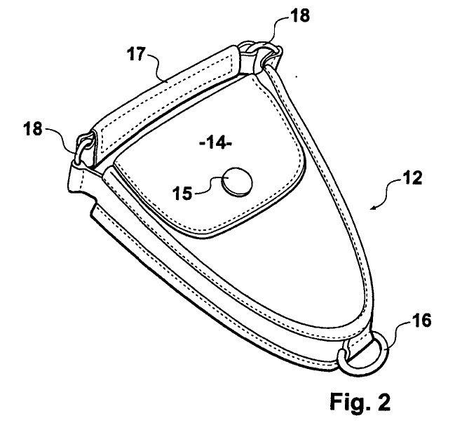

Turning now to FIG. 2; a container in the form of a receptacle pouch is shown generally referenced 12. The container has a cover flap 14 which may be secured to an outer surface of the container by a fastener 15 which may comprise a dome clip, or a magnetic fastener for example. Other forms of fastening device may be used, but a fastener is not essential. In the preferred embodiment the container is constructed from a flexible but suitably robust material such as leather, although other materials may be used. The container is provided in a substantially triangular shape. The first end of the container which is at an apex of the triangle shape includes a connecting loop, such as another D ring 16, for example, which is adapted to engage with clip 3 of the strap (refer FIG. 1). The apex is rounded in the preferred embodiment (as shown in the drawing Figures) and the walls either side of the apex are preferably curved. This provides more carrying space within the container and provides an aesthetically pleasing appearance. The second end of the container 12 has a handle 17 which is located along a side of the triangle substantially opposite to the apex. In the example shown in FIG. 2, the handle 17 is attached to the body of the container using O rings or similar connectors 18. The construction is generally robust and handle 17 is adapted to be comfortable for a user's hand to grasp so that the body of the handle 17 may be located in use within a user's first or hand. In the preferred embodiment the handle 17 comprises a number of layers of leather or similar material, and extends substantially from one side of the container 12 to the other. The container handle 17 may include a substantially rigid or resilient inner member to provide increased rigidity and make the leash easier for a user to grasp. The triangular shape allows a convenient handle to be provided which is easily grasped while also allowing forces from the strap to be distributed to the handle.

The apparatus of FIGS. 1 and 2 is adapted to be connected together so that the D ring 16 is captured within clip 3 of the strap of FIG. 1. Therefore, the clip 2 of strap I can be connected to an animal collar, and in this way a leash is provided comprising the container 12 and the strap 1. In this document, reference is made to clips engaging with loops such as D rings. However, those skilled in the art will appreciate that other connection arrangements may be used, and that the location of clips and loops may be reversed between components. For example, loops may be provided at either end of the strap 1 for engagement with clips provided on the collar and container.

A user can hold the handle 17 of the container and in this way restrain the animal wearing the collar. Therefore, the handle 17 functions as both a handle for the container 12, and as a handle for an animal leash. The container 12 is of a suitable size to contain and protect personal items, valuables or similar items belonging to the user such as keys, money, wallet, credit cards, medicines, communication devices such as a pager or cell phone, PDA (Personal Digital Assistant) etc. The container may also be provided with a plastic bag for collecting the excrement from the animal, and be used for carrying such a bag of excrement duly collected by the user for later disposal.

The leash apparatus comprising the container 12 and strap 1 has the advantage that when a user wishes to secure an animal to which the leash is attached, the user can simply unclip clip 3 from the container, then loop the end of strap 1 that carries clip 3 about a fixed or stationary object such as a post and secure the clip to fixed D ring 10. This allows the animal to be restrained to the fixed object while a user continues to carry the container without leaving the container in a position where its contents could be stolen or otherwise tampered with. The user is also free to take the container into a store, for example, and access the contents of the container such as a wallet or money to make a purchase.

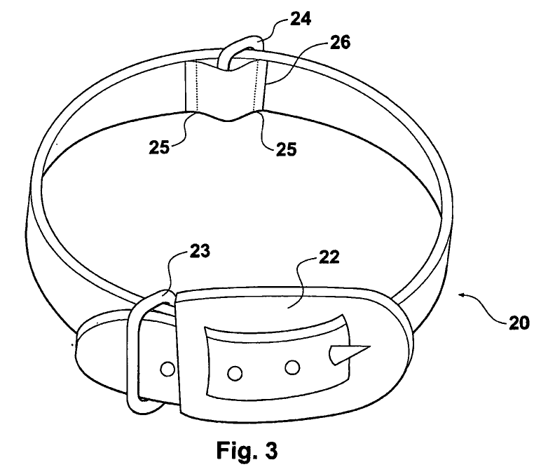

Turning now to FIG. 3, an animal collar is shown generally referenced 20. The collar includes a fastening mechanism such as buckle 22 to securely fasten the collar about the animal (about the neck of the animal, for example).

At a substantially opposite position on the collar, a connector such as D ring 24 is fixably connected to the collar, for example by stitching 25, so that it cannot substantially move relative to the collar. The D ring 24 is in use connected to clip 2 of FIG. 1. The fixed position of the D ring 24 has the advantage that it is remote from the buckle 22 which is in use positioned adjacent to the throat of the animal wearing the collar. In this way, the D ring 24 is conveniently provided at a position on the animal which is usually close to the user and convenient for attachment and continued engagement of clip 2.

Furthermore, many owners of domestic animals provide a light emitting device, commonly referred to as a pet light and sold under the trade mark Pet Blinkers™, which clips on a collar adjacent to a buckle of the collar where the light is easily visible at night for identification of the animal. A connecting loop such as D ring 23 (see FIG. 3) is provided for attachment of devices such as Pet Blinkers™ or safety lights, registration tags or identification tags. Ring 23 also preferably contains the tongue of the collar. Providing the collar attachment D ring 24 at a position opposite the buckle means that the D ring 24 does not interfere with the operation or effectiveness of the light.

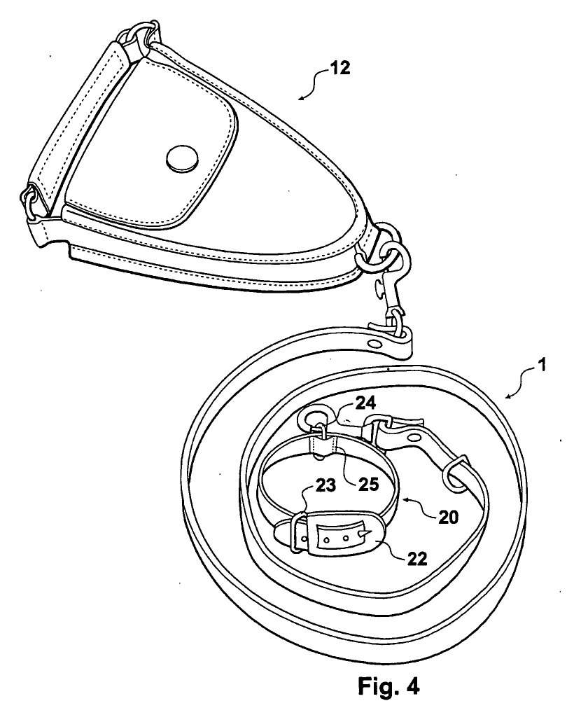

Turning now to FIG. 4, the apparatus of FIGS. 1 to 3 is shown in an assembled condition, ready for the collar 20 to be fastened about the neck of an animal.

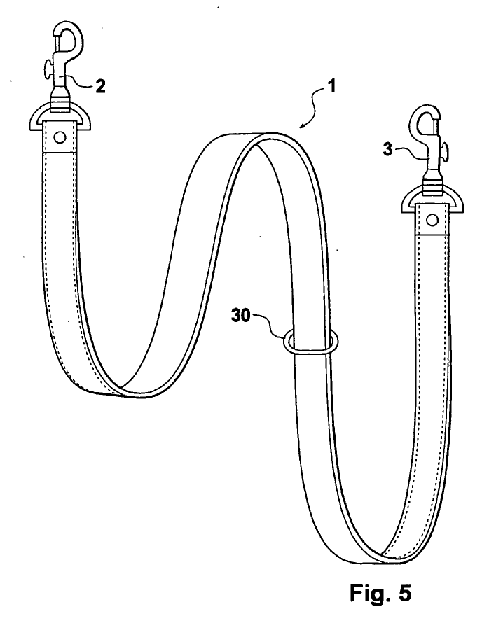

In FIG. 5, an alternative example of the strap 1 is illustrated. Like reference numerals relate to like features of the strap previously described. The difference with the strap shown in FIG. 5 is that rather than having a fixed D ring 10, a “floating” or sliding D ring or loop 30 is provided. This has the advantage that it allows the strap to be affixed to a wide variety of different sized objects. For example, the fixed D ring of FIG. 1 may only allow the strap to be looped about a parking meter post, whereas the sliding D ring 30 of FIG. 5 may allow the strap to be looped about a lamp post, since the larger diameter of the lamp post can be accommodated by allowing the ring 30 to slide further along the strap to affix it to the clip 3.

Another advantage with the construction of FIG. 5 is that the sliding D ring 30 allows a tight engagement of the strap to be made with the post or other object about which the strap is placed.

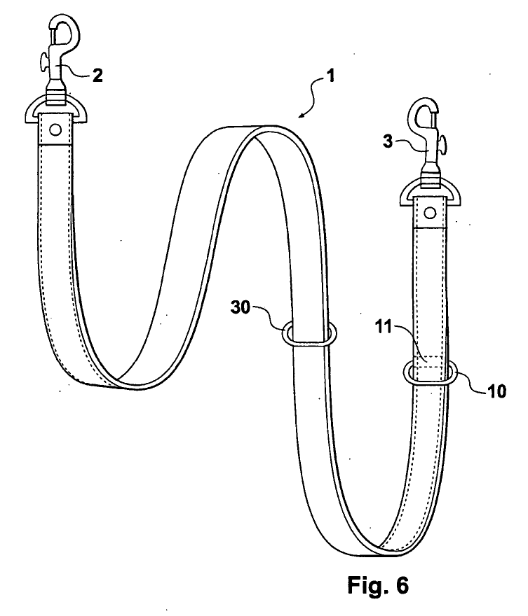

In FIG. 6 yet another example of a preferred strap is illustrated. Again, like reference numerals refer to like figures, and in this example it will be seen that both the fixed D ring 10 and the floating D ring 30 are provided. This arrangement shown in FIG. 6 allows a number of different options for a user. The options of using a fixed D ring or the floating D ring to fasten the strap to fixed objects are available. There is also the option of the fixed D ring being used to form a handle in the end of the strap by connecting clip 3 to fixed D ring 10. This may be desirable when a user needs to disconnect the container 12 while handling the animal.

Where in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope or spirit of the invention.

1-14. (canceled)

15. A leash comprising an elongate strap having a first end and a second end, the first end having a collar connector for connection to an animal collar, the second end having a container connector container being constructed from a substantially flexible material and having a substantially triangular shape, and including a strap connector provided at or adjacent to an apex of the triangular shape for connection to the container connector, and the container including a leash handle at an opposite side of the triangular shape substantially opposite the apex, the leash handle being disposed substantially parallel to the opposite side and being adapted to be grasped by the hand of the user, and wherein the leash includes a slideable connector slideably mounted about the strap so as to be capable of moving along the strap, the slideable connector being adapted to engage with the container connector to allow the leash to be attached about a fixed object without the container or handle being attached to the leash.

16. A leash as claimed in claim 15 including a collar having a strap connector adapted to engage the collar connector.

17. A leash as claimed in claim 16 wherein the collar includes a fastening loop for attaching one or more of: a registration tag; an identification tag; a light emitting device.

18. A leash as claimed in claim 17 wherein the collar includes a collar fastening means for fastening the collar about the animal, the fastening means being provided substantially adjacent to the fastening loop.

19. A leash as claimed in claim 17 wherein the collar strap connector is fixedly mounted on the collar in a location substantially opposite the fastening loop.

20. A leash as claimed in claim 18 wherein the collar strap connector is fixedly mounted on the collar in a location substantially opposite the fastening means.
